(19) United States
(12) Patent Application Publication
(10) Pub. No.: US 2006/0245581 A1
(43) Pub. Date: Nov. 2, 2006

(54) System and method for sensing information handling system jack activity

(76) Inventors: Joshua N. Alperin, Austin, TX (US); Douglas Peeler, Austin, TX (US)

Correspondence Address: HAMILTON & TERRILE, LLP, P.O. BOX 203518, AUSTIN, TX, 78720, US

(21) Appl. No.: 11/117,277

(22) Filed: Apr. 28, 2005

(51) Int. Cl. H04M 3/00

(52) U.S. Cl. 379/332

(57) ABSTRACT

The configuration of active jacks at an information handling system is sensed by temporarily diverting an analog-to-digital converter from a primary function upon detection of a change of the configuration of active jacks. A jack sense circuit outputs a unique voltage for each configuration of jacks, such as with a resistor tree. A change in the jack sense voltage generates an interrupt by a jack sense interrupt, which communicates the interrupt to a multiplexer. The multiplexer temporarily interfaces the jack sense output voltage with the analog-to-digital converter to have the jack sense output voltage converted to digital information that identifies the jack configuration. After detection of the jack configuration, the multiplexer returns the analog-to-digital converter to its primary function, such as converting analog microphone signals to digital information.

### BACKGROUND OF THE INVENTION

1. Field of the Invention

The present invention relates in general to the field of information handling system jack connections, and more particularly to a system and method for sensing information handling system jack activity.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems have gradually transformed from having a primary use as business tools into high-tech entertainment platforms. Users often play audio and video files from digital storage media, such as Compact Discs (CDs) and Digital Versatile Discs (DVDs). Information handling systems have, indeed, transformed the entertainment industry by providing digital recording and editing capabilities. For instance, consumers now commonly create their own DVDs with digital cameras and information handling systems that burn digital images to DVDs. As a result, consumers desire increased flexibility in the formats and media that information handling systems use. Industry has responded by including an increasing number of audiovisual formats to record and present information. One example is the High Definition Audio (HDA), which defines standardized formats for digital audio information.

Some difficulties that arises with the integration of greater audiovisual capability in information handling systems include the greater cost of the various hardware devices involved, such as devices that support peripheral speakers and microphones, as well as the greater footprint and power consumption associated with such devices. For instance, the HDA standard describes the use of a “tree” of resistors to determine the presence or absence of various audio connectors. FIG. 1 depicts an example of the jack sense resistor tree 10 of the HDA specification. Plural resistors 12 each associate with one of plural switches 14 so that each combination of closed switches 14 will output a unique voltage at codec jack sense pin 16. Thus, by closing a switch on insertion of a jack and opening the switch upon removal of the switch, a unique voltage is provided to allow the information handling system to sense jack activity. However, in order for the sensed jack activity information to have a useful form for the information handling system, an analog-to-digital converter has to measure the discrete voltage steps possible with the tree and convert the measured voltage into digital information for use by the information handling system. This adds to the cost of the jack activity sensing circuitry and increases the footprint and power consumption of the circuitry.

### SUMMARY OF THE INVENTION

Therefore a need has arisen for a system and method which senses jack activity analog signals with reduced hardware circuitry.

In accordance with the present invention, a system and method are provided which substantially reduce the disadvantages and problems associated with previous methods and systems for sensing jack activity at an information handling system. An analog-to-digital converter is temporarily diverted from a primary function upon detection of a change in the configuration of jacks interfaced with an information handling system. The analog-to-digital converter converts a jack sense signal from an analog to a digital value and then returns to the primary function.

More specifically, a jack sense circuit, such as a resistor tree, outputs a unique voltage for each of plural configurations of jacks interfaced with an information handling system. Upon detection of a change in the jack sense circuit output, a jack sense interrupt signals a multiplexer to have the jack sense signal measured by an analog-to-digital converter. The multiplexer temporarily diverts the analog-to-digital converter from a primary function, such as converting analog microphone signals to digital information, to receive the jack sense signal from the jack sense circuit and output the jack configuration as digital information. Once the jack configuration is converted to digital information, the multiplexer returns the analog-to-digital converter to its primary function, such as converting analog microphone signals to digital information, until another change in the jack sense circuit output generates another interrupt.

The present invention provides a number of important technical advantages. One example of an important technical advantage is that reduced cost is achieved by multiplexing an existing analog-to-digital converter between a primary use, such as an audio codec used to convert microphone signals, and jack sensing. The impact on the primary use is minimal since the time used to sense jack activity is relatively small. Thus, for instance, multiplexing an audio codec used for detection of audio signals at a microphone to briefly sense jack activity and then continue with detection of audio signals produces virtually no degradation of the quality of the detected audio signals. However, component cost, footprint and power consumption are each reduced by the elimination of a separate analog-to-digital converter.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts the resistor tree suggested by the High Definition Audio standard to detect the configuration of jacks interfaced with an information handling system; and

FIG. 2 depicts block diagram of an information handling system having an analog-to-digital converter that performs a primary function of microphone signal conversion and the intermittent temporary function of jack configuration signal conversion.

### DETAILED DESCRIPTION

The configuration of jacks active at an information handling system is converted from an analog to a digital value by temporarily diverting an analog-to-digital converter from a primary function. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

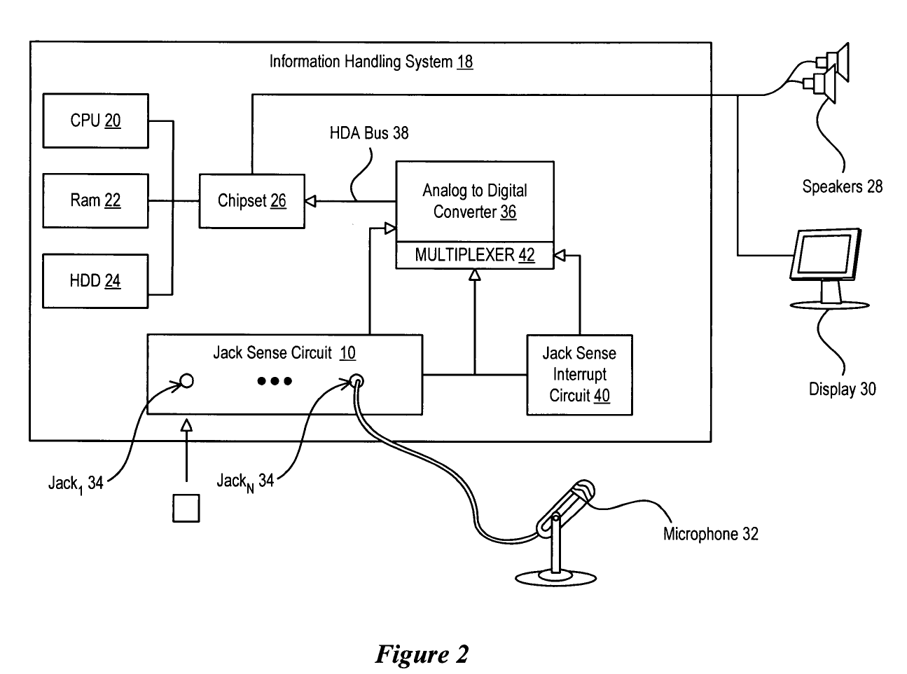

Referring now to FIG. 2, a block diagram depicts an information handling system 18 having an analog-to-digital converter that performs a primary function and a secondary function. The primary function is conversion of microphone analog signals into digital information. The secondary function is the intermittent temporary function of jack configuration signal conversion when the configuration of jacks interfaced with information handling system 18 changes. Information handling system 18 has plural processing components that cooperate to process information, such as information input by a user or information for presentation to a user. For instance, a CPU 20, RAM 22 and hard disk drive 24 support applications that interact with a user and communicate information with a chipset 26. Chipset 26 generally supports user interface peripherals, such as a speaker 28 that converts audio signals to sound, a display 30 that converts visual signals to images, and a microphone 32 that converts sounds into electrical signals. To varying degrees, each interface converts analog signals to digital values. For instance, microphone 32 interfaces with a jack 34 to send analog signals representing detected sounds to an analog-to-digital converter 36. The analog-to-digital converter converts the analog signals to digital values that are sent over a high definition audio bus 38 to chipset 26.

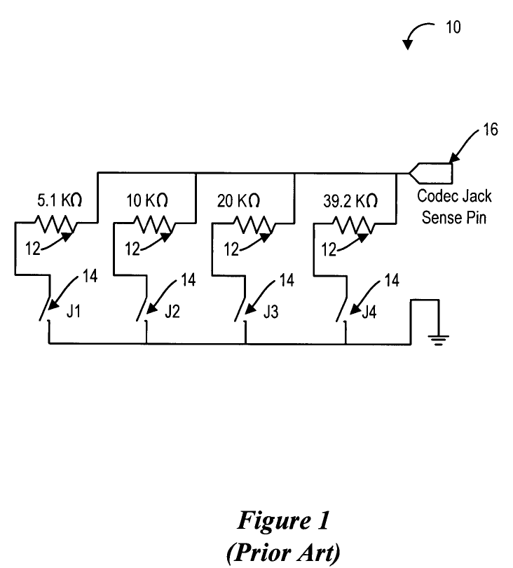

Jack sense circuit 10 outputs a unique voltage for each configuration of active jacks, such as with the resistor tree depicted in FIG. 1. The analog voltage value output by jack sense circuit 10 is communicated to a jack sense interrupt circuit 40 and to a multiplexer 42. When jack sense interrupt circuit 40 detects a change in the value output from jack sense circuit 10, such as will occur when a jack transitions between active and inactive states, an interrupt signal is sent to multiplexer 42. On receipt of the interrupt signal, multiplexer 42 diverts analog-to-digital converter 36 from its primary function of receiving the signal of microphone 32 to a secondary function of instead receiving the signal of jack sense circuit 10. Analog-to-digital converter 36 converts the analog jack sense circuit to a digital value for communication over high definition audio bus 38 to chipset 26. Once the conversion of the jack sense signal is complete, such as after a brief predetermined time period, multiplexer 42 resumes the interface of analog-to-digital converter 36 to the primary function of converting signals from microphone 32. The time period allowed for the conversion of the jack sense signal is set at a relatively small value to have minimal impact on the quality of the signal converted by the microphone.

In alternative embodiments, analog-to-digital converter 36 may have a variety of primary functions, including conversion of audio information or conversion of video information. In one embodiment, an analog-to-digital converter is selected from plural converters based on its idle state in which the primary function is not currently being performed. Although the described embodiment depicts conversion of high definition audio jack activity, other types of jack connections may be handled by temporary diversion of an analog-to-digital converter from a primary function to a jack sensing function.

Although the present invention has been described in detail, it should be understood that various changes, substitutions and alterations can be made hereto without departing from the spirit and scope of the invention as defined by the appended claims.

What is claimed is:

1. An information handling system comprising:
plural processing components operable to process information;
one or more user interface devices operable to present the information to a user or to receive information from the user, the user interface device having an analog-to-digital converter that interacts with the information;
plural jacks, each jack operable to interface with a peripheral device;
a jack sense circuit interfaced with the plural jacks and operable to output plural voltages, each of the plural voltages associated with a predetermined configuration of interfaced jacks;
a jack sense interrupt operable to detect a change in the voltage output from the jack sense circuit and to generate an interrupt signal in response to the detected change; and
a multiplexer interfaced with the analog-to-digital converter, the jack sense circuit and the jack sense interrupt, the multiplexer operable to selectively interface the jack sense circuit with the analog-to-digital converter at the generation of an interrupt signal, the analog-to-digital converter operable to determine the configuration of interfaced jacks from the voltage output by the jack sense circuit.

2. The information handling system of claim 1 wherein the interface device comprises a microphone having an analog-to-digital converter to convert audio signals from analog to digital signals.

3. The information handling system of claim 1 wherein the interface device comprises a video display having an analog-to-digital converter to convert video signals from analog to digital signals.

4. The information handling system of claim 1 wherein the interface device comprises a speaker having an analog-to-digital converter to convert audio signals from analog to digital signals.

5. The information handling system of claim 4 wherein the speaker comprises a headset.

6. The information handling system of claim 1 wherein the jacks comprise high definition audio interface jacks.

7. The information handling system of claim 1 wherein the jack sense circuit comprises a resistor tree.

8. A method for determining the configuration of jacks interfaced with an information handling system, the method comprising:
generating a unique voltage for each of plural configurations of jacks interfaced with the information handling system;
detecting a change in the generated voltage generated at a change of the configuration of jacks; and
interrupting an analog-to-digital converter from a primary function to convert the unique voltage to digital information representing the configuration of jacks.

9. The method of claim 8 further comprising:
returning the analog-to-digital converter to the primary function upon conversion of the unique information to digital information.

10. The method of claim 9 wherein returning further comprises returning the analog-to-digital converter to the primary function within a predetermined time.

11. The method of claim 8 wherein the jacks comprise high definition audio jacks.

12. The method of claim 8 wherein the primary function comprises converting analog microphone signals to digital information.

13. The method of claim 8 wherein the primary function comprises converting speaker signals from analog to digital signals.

14. The method of claim 8 wherein the primary function comprises converting video signals for analog to digital signals.

15. A system for sensing a configuration of active jacks, the system comprising:
an analog-to-digital converter operable to convert analog voltage to digital information, the analog-to-digital converter having a primary function;
a jack sense circuit operable to output a unique voltage for each of plural jack configurations;
a jack sense interrupt operable to issue an interrupt signal if the jack sense circuit output voltage changes;
a multiplexer interfaced with the jack sense interrupt, the jack sense circuit and the analog-to-digital converter, the multiplexer operable to temporarily divert the analog-to-digital converter from the primary function upon detection of a jack sense interrupt, the analog-to-digital converter operable to convert the unique voltage of the jack sense circuit into digital information that identifies the configuration of jacks.

16. The system of claim 15 wherein the jacks comprises high definition audio jacks.

17. The system of claim 16 wherein the jack sense circuit comprises a resistor tree.

18. The system of claim 15 wherein the primary function comprises converting analog microphone signals to digital information.

19. The system of claim 15 wherein the primary function comprises converting analog audio signals to digital information.

20. The system of claim 15 wherein the primary function comprises converting analog video signals to digital information.
